(19) United States
(12) Patent Application Publication
(10) Pub. No.: US 2010/0312848 A1
(43) Pub. Date: Dec. 9, 2010

(54) Method and System for Parallel Call Setup

(76) Inventors: Yury Bakshi, Morganville, NJ (US); David A. Hoeflin, Middleton, NJ (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/481,179

(22) Filed: Jun. 9, 2009

(51) Int. Cl. G06F 15/16

(52) U.S. Cl. 709/207

(57) ABSTRACT

A computer readable storage medium stores a set of instructions executable by a processor. The instructions are operable to receive a request to initiate a communications session. The instructions are further operable to determine whether the request is a high-priority request. The instructions are further operable to initiate a high-priority communication setup if the request is a high-priority request. The high-priority communication setup is a parallel communication setup.

### BACKGROUND

Modern telecommunications networks typically comprise complicated, interconnected networks of nodes and links. Network providers strive to provide service to their customers both during normal operations and during situations when the network is damaged, either moderately or severely. Under network damage conditions, network providers may wish to prioritize certain types of calls in order to minimize connection delays and call blocking.

### SUMMARY OF THE INVENTION

The present invention is directed to a computer readable storage medium storing a set of instructions executable by a processor. The instructions operable to receive a request to initiate a communications session, determine whether the request is a high-priority request, initiate a high-priority communication setup if the request is a high-priority request. The high-priority communication setup is a parallel communication setup.

The present invention is further directed to a system including a plurality of servers connected to a communications network and a user terminal connected to the communications network. The user terminal receives a request from a user to initiate a communications session. The user terminal initiates a high-priority communication setup process if the request is a high-priority request. The high-priority communication setup process is a parallel communication setup process.

The present invention is further directed to a device including a memory, a processor, and an input means. The input means receives a request to initiate a communications session. The device determines whether the request is a high-priority request. The device initiates a high-priority communication setup if the request is a high-priority request. The high-priority communication setup is a parallel communication setup.

### BRIEF DESCRIPTION OF THE DRAWINGS

FIG. 1 shows a partial schematic view of an exemplary communications network according to the present invention.

FIG. 2 shows an exemplary method for prioritizing high-importance communications in a communications network according to the present invention.

### DETAILED DESCRIPTION

The exemplary embodiments of the present invention may be further understood with reference to the following description and the appended drawings, wherein like elements are referred to with the same reference numerals. The exemplary embodiments describe methods and systems for achieving improved connection success rates and decreased connection delays for high-priority sessions in a communications network. In the exemplary embodiments, such sessions are initiated simultaneously in parallel on multiple call setup paths. The exemplary embodiments will be described herein with specific reference to the system components and process steps required to establish a VoIP communications session; however, those of skill in the art will understand that the same principles may be equally applicable to other types of communications sessions. Described herein are systems and methods that are especially effective in improving survivability of low-volume mission-critical calls/requests when a network undergoes multiple simultaneous failures. Those of skill in the art will understand that network failures may be due to natural disasters (e.g., hurricanes, earthquakes, etc.), due to manmade disasters (e.g., steam pipe explosions, acts of war, etc.), or due to network-related outages (e.g., software failure, power failure, etc.).

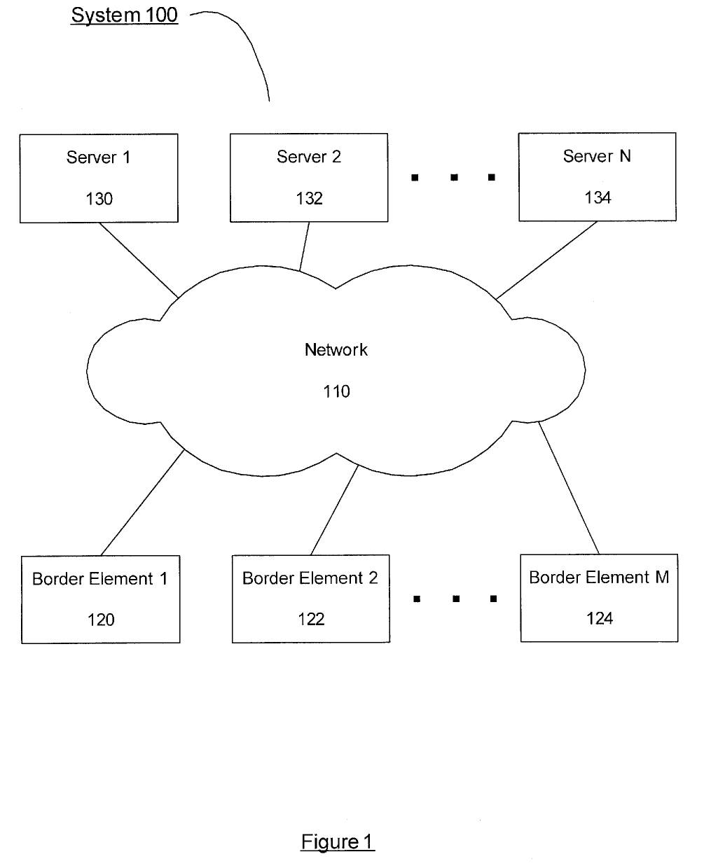

FIG. 1 illustrates a partial schematic view of a system 100 according to the present invention. The system 100 may include a communications network 110; in this exemplary embodiment, the network 110 is a VoIP communications network, but the broader principles of the invention may be equally applicable to other types of networks. The network 110 may include a plurality of nodes and links connecting various components, which are not shown for clarity. For example, the network 110 may comprise backbone routers and high-capacity trunk data links, etc.

The system 100 may also include a plurality of border elements 120, 122 and 124. FIG. 1 illustrates three border elements, but the system 100 may include a larger number M of border elements that may be designated, sequentially, as border element 1, border element 2, . . . , border element M. The border elements 120, 122 and 124 may be accessed by users with equipment capable of connecting to the system 100, such as computing devices including memory and processors for storing and executing VoIP software; the precise nature of such user equipment is outside the scope of the present invention.

The system 100 may also include a plurality of servers 130, 132 and 134. As for the border elements discussed above, FIG. 1 illustrates three servers, but the system 100 may include a larger number N of servers that may be designated, sequentially, as server 1, server 2, . . . , server N. The servers 130, 132 and 134 may be application servers that are contacted by users in order to obtain information that is required to complete a VoIP communication. In other embodiments, the servers 130, 132 and 134 may be another type of server that are contacted by a user in order to establish a different type of communication session. The servers 130, 132 and 134 may be functionally equivalent to one another; a user need only contact one of the servers (e.g., server 132) in order to initiate a communication session (e.g., a VoIP call) and it may be any of the servers 130, 132 and 134. The servers 130, 132 and 134 may include both hardware components (e.g., processors, computer readable storage media, etc.) and software components to perform the desired functionality.

Typically, in order to initiate a VoIP call, a user may contact one of the border elements (e.g., border element 120), which sends a SIP Invite request to one of the application servers (e.g., server 132). The server 132 responds with a Trying response to indicate to the border element 120 that it received the request, and so that the border element 120 does not attempt retransmissions. The server 132 then processes the request. Once the server 132 has prepared the information required for the border element 120 to continue with call setup, it sends a Multiple Choice response to the border element 120 with that information. The border element 120 completes its exchange with the server 132 by sending an acknowledgement message. Once this exchange is complete, the sending border element 120 may continue with call setup by sending messages to a recipient border element or to another server requesting further processing; however, the remainder of call setup is beyond the scope of the present invention, and thus will not be described further.

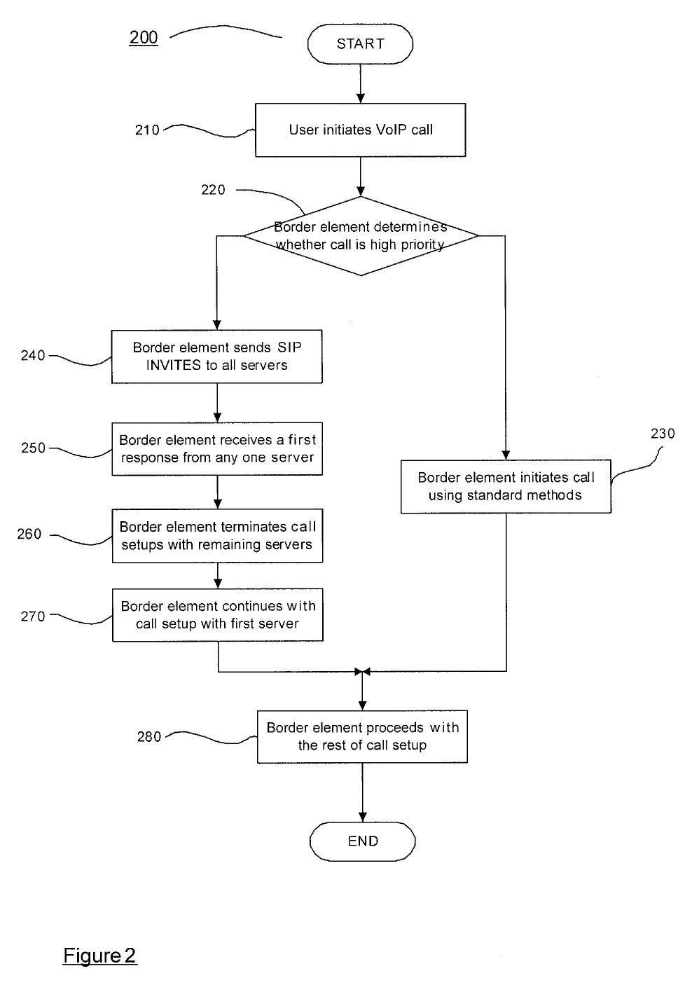

More often than not, border elements do not maintain server-related status data and are not unaware of the server availability. Such “ignorant” border elements continue to distribute arriving requests/calls to all servers, including the ones that are unavailable. If the “ignorant” border element 120 is unsuccessful at querying the server 132, it may typically retransmit the call setup request (e.g., SIP Invite) to the same failed server 132 for a predefined period of time (e.g., 3-4 seconds), and then may redistribute/retry the call setup request to another server in the predefined manner. The number of the allowed call/request retries to other servers is usually limited to reduce the call setup delay. If each extra retry results in 3.5 sec of extra call set up delay then two retries will result in 7 sec of extra delay. Three or more sequential retries may add more than 10 sec to a call setup, which may be prohibitive. This method, wherein one initial request is sent and, if necessary, followed by retries to other servers that are also sent one at a time, may be thought of as a “sequential” call setup process. However, the sending of subsequent queries adds time to the connection process, and if some of the servers are unavailable, there is a possibility that the call will not be completed at all. Thus, network providers may wish to provide preferential treatment to high-priority or mission-critical calls. FIG. 2 illustrates an exemplary method 200 for such preferencing. The method 200 will be described with reference to the system 100.

In step 210, a user of a communications device (e.g., a computer with VoIP hardware and software) communicates with the border element 120 to initiate a VoIP call. In step 220, the border element 120 determines whether the call being initiated is high-priority. The definition of high-priority may depend on the nature of the system 100 and thus may vary among differing implementations. In some implementations, this may include communications to or from government or emergency personnel. If the call is not high-priority, the method continues at step 230, in which the border element 120 proceeds with a sequential call setup process as described above. Methods by which this may be achieved are known in the art and thus will not be discussed in further detail.

If the border element 120 determines that the call is high-priority, the method continues at step 240. In step 240, the border element 120 sends SIP Invites to all of the servers 130, 132 and 134. (Those of skill in the art will understand that the SIP Invite is specific to VoIP communications and that the nature of the initial communication may vary for different types of communication.) After sending the SIP Invites, the border element 120 waits to receive a response from the servers 130, 132 and 134; this is substantially similar to the way the border element 120 would wait for a response under standard methods, except that the border element 120 is simultaneously waiting for responses from all three servers 130, 132 and 134. Those skilled in the art will also understand that the term “all servers” in step 240 does not necessarily mean that every single server in a large telecommunication system will be contacted. For example, a border element may include instructions as to which servers to contact or a number of servers to contact. Such parallel call setup may introduce a greater load to the border elements, servers and network than a sequential call setup, due to the simultaneous transmission of multiple requests; however, because parallel call setup may be used only for high-priority communication requests, which may typically represent only a very small portion of network traffic, the overall performance impact be insignificant.

In step 250, the border element 120 receives a first response (e.g., a Trying response) from one of the servers (e.g., server 132). The identity of the first responding server may depend on a variety of factors. For example, damage to one of the servers may result in that server being unable to respond at all; damage to intervening network nodes or links may result in the SIP INVITE not reaching one or more of the servers, or one or more response messages being unable to reach the border element 120; a high number of calls currently being handled may simply result in one functioning and accessible server taking longer to respond than another functioning and accessible server; etc. Thus, in one possible exemplary failure scenario, server 130 may be damaged and server 134 may be overloaded with existing traffic, resulting in a first response from server 132 as mentioned above.

In step 260, upon receiving the first response, the border element 120 terminates the remaining incomplete call setup sequences. The way in which this is accomplished may vary among different implementations of the exemplary embodiment. In one implementation, the border element 120 may send cancellation requests (e.g., SIP Cancel request) to the remaining servers (e.g., in the example above, server 130 and server 134) in order to inform them that no call setup will be continuing between them and the border element 120. In another implementation, the border element 120 may simply ignore any subsequent responses and proceed with call setup using the first responding server (e.g., server 132). In step 270, the border element 120 continues with the remainder of call setup using the first responding server (e.g., server 132). This may proceed substantially as known in the art. After step 270, or after step 230 described above, the method 200 terminates. The case in which no response is received from any of the servers is not included in FIG. 2. Depending on implementation, the border element 120 may terminate the call using standard methods as known in the art. It may also resend call initiation requests (e.g. SIP Invite requests) to all servers once or several times using standard procedures as known in the art.

The exemplary embodiments may reduce both call blocking and setup time. In a sequential call setup with a limited number of retries, call blocking may occur if each of the limited number of attempts to connect is made to an unavailable server. It will be apparent to those of skill in the art that the exemplary embodiments may reduce or eliminate the occurrence of call blocking by making simultaneous connection attempts to all appropriate servers, thus resulting in call blocking only if all such servers are unavailable. Similarly, in a sequential call setup, each retry adds delay to the connection process; a typical VoIP application may involve a delay of several seconds per such attempt. It will be apparent to those of skill in the art that a parallel call setup will involve no retries, and thus no retry-related delays. A parallel call setup may introduce a greater load to the border elements, servers and network than a sequential call setup, due to the simultaneous transmission of multiple requests; however, because parallel call setup is used only for high-priority communication requests, which may typically represent only a small portion of network traffic, the overall performance impact may be insignificant.

Those of skill in the art will understand that the exemplary embodiments of the present invention described above may be implemented in a variety of manners. Such implementations may include computer hardware (e.g., processors and storage media), computer software, or a combination thereof.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the instructions operable to:
receive a request to initiate a communications session;
determine whether the request is a high-priority request; and
initiate a high-priority communication setup if the request is a high-priority request, the high-priority communication setup being a parallel communication setup.

2. The computer readable storage medium of claim 1, wherein the instructions are further operable to:
initiate a low-priority communication setup if the request is not a high-priority request, the low-priority communication setup being a sequential communication setup.

3. The computer-readable storage medium of claim 1, wherein the instruction to initiate the high-priority communication setup comprises sub-instructions to:
send, substantially simultaneously, a plurality of setup requests to each of a corresponding plurality of servers;
receive a first response from a first-responding one of the plurality of servers; and
continue the high-priority communication setup using only the first-responding one of the plurality of servers.

4. The computer-readable storage medium of claim 3, wherein the instruction to initiate the high-priority communication setup further comprises a sub-instruction to:
send a cancellation request to each of the plurality of servers other than the first-responding one of the servers.

5. The computer-readable storage medium of claim 3, wherein the servers are VoIP Application Servers.

6. The computer-readable storage medium of claim 3, wherein the setup requests are SIP Invites.

7. The computer-readable storage medium of claim 1, wherein the communications session is a VoIP call.

8. A system, comprising:
a plurality of servers connected to a communications network; and
a user terminal connected to the communications network, the user terminal receiving a request from a user to initiate a communications session, the user terminal initiating a high-priority communication setup process if the request is a high-priority request, the high-priority communication setup process being a parallel communication setup process.

9. The system of claim 8, wherein the communications network is the Internet.

10. The system of claim 8, the user terminal further initiating a low-priority communication setup process if the request is not a high-priority request, the low-priority communication setup process being a sequential communication setup process.

11. The system of claim 8, wherein the plurality of servers are VoIP application servers.

12. The system of claim 8, wherein the communications session is a VoIP call.

13. The system of claim 8, wherein the user terminal initiates the high-priority communication setup process by sending, substantially simultaneously, a plurality of setup requests to each of a corresponding plurality of servers, receiving a first response from a first-responding one of the plurality of servers, and continuing the high-priority communication setup using only the first-responding one of the plurality of servers.

14. The system of claim 8, wherein the user terminal sends a cancellation request to each of the plurality of servers other than the first-responding one of the servers.

15. A device, comprising:
a memory;
a processor; and
an input means receiving a request to initiate a communications session, the device determining whether the request is a high-priority request, the device initiating a high-priority communication setup if the request is a high-priority request, the high-priority communication setup being a parallel communication setup.

16. The device of claim 15, wherein the device initiates a low-priority communication setup if the request is not a high-priority request, the low-priority communication setup being a sequential communication setup.

17. The device of claim 15, wherein device initiates the high-priority communication setup by:
sending, substantially simultaneously, a plurality of setup requests to each of a corresponding plurality of servers;
receiving a first response from a first-responding one of the plurality of servers; and
continuing the high-priority communication setup using only the first-responding one of the plurality of servers.

18. The device of claim 17, wherein device sends a cancellation request to each of the plurality of servers other than the first-responding one of the servers.

19. The device of claim 17, wherein the setup requests are SIP Invites.

20. The device of claim 15, wherein the communications session is a VoIP call.
